(19) United States
(12) Patent Application Publication
(10) Pub. No.: US 2021/0029966 A1
(43) Pub. Date: Feb. 4, 2021

(54) ANIMAL CLEANING SYSTEM

(71) Applicant: Ashley Deering, Gallatin, TN (US)

(72) Inventor: Ashley Deering, Gallatin, TN (US)

(21) Appl. No.: 16/528,112

(22) Filed: Jul. 31, 2019

(51) Int. Cl. A01K 13/00

(52) U.S. Cl. CPC A01K 13/001

(57) ABSTRACT

An animal cleaning system to wash a pet with a liquid, including a liquid control unit to control movement of the liquid therethrough, and a wearable cleaning device removably disposed on at least a portion of the liquid control unit to dispense the liquid on at least a portion of the pet.

### BACKGROUND

### 1. Field

The present general inventive concept relates generally to a cleaning system, and particularly, to an animal cleaning system.

### 2. Description of the Related Art

Pets are likely to accumulate dirt and/or odors on themselves during their day-to-day activities. Unless a pet loves bath time and shaking off in the sun, most pet owners certainly know washing the pet can be a challenge. Just like humans, pets need to be bathed to help fight bacteria and other foreign organisms living on their coat and body. Keeping the pet clean contributes to preventing skin infections and keeps the pet smelling good.

However, using a shower head and/or a water hose is inefficient due to the pet's movements.

Therefore, there is a need for an efficient animal cleaning system that is controlled and makes cleaning enjoyable for the pet.

### SUMMARY

The present general inventive concept provides an animal cleaning system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an animal cleaning system to wash a pet with a liquid, the animal cleaning system including a liquid control unit to control movement of the liquid therethrough, and a wearable cleaning device removably disposed on at least a portion of the liquid control unit to dispense the liquid on at least a portion of the pet.

The liquid control unit may include a body, an inner tube disposed within at least a portion of an interior of the body to contain the liquid therein, and a selector rotatably disposed on at least a portion of the body to select a flow of the liquid within the body.

The liquid control unit may further include a valve disposed within at least a portion of the interior of the body to adjust the flow of the liquid within the body in response to rotation of the selector.

The flow of the liquid within the body is based on at least one of an outlet position, a soap position, and a rinse position.

The wearable cleaning device may include another body, and at least one liquid outlet disposed on at least a portion of a surface of the another body to release the liquid from within the another body.

The animal cleaning system may further include a haptic unit disposed on or within at least a portion of the wearable cleaning device to massage the pet in response to vibration of the haptic unit.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a perspective view of an animal cleaning system, according to an exemplary embodiment of the present general inventive concept;

FIG. 2A illustrates a front view of a liquid control unit, according to an exemplary embodiment of the present general inventive concept;

FIG. 2B illustrates a front sectional view of the liquid control unit, according to an exemplary embodiment of the present general inventive concept;

FIG. 2C illustrates a bottom view of the liquid control unit, according to an exemplary embodiment of the present general inventive concept; and

FIG. 3 illustrates a top view of a wearable cleaning device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Animal Cleaning System 100
Liquid Control Unit 110
Body 111
Handle 111a
Water Outlet 111b
Inner Tube 112
First End 112a
Second End 112b
Cleaning Liquid Cover 112c
Water Filter 112d
Selector 113
Valve 114
Cleaning Liquid Container 115
Auxiliary Tube 116
Wearable Cleaning Device 120
Body 121
Liquid Inlet 122
Liquid Outlets 123
Limb-Receiving Aperture 124
Handles 125
Body Fasteners 126
Neck Fastener 127
Haptic Unit 130
Power Source 140

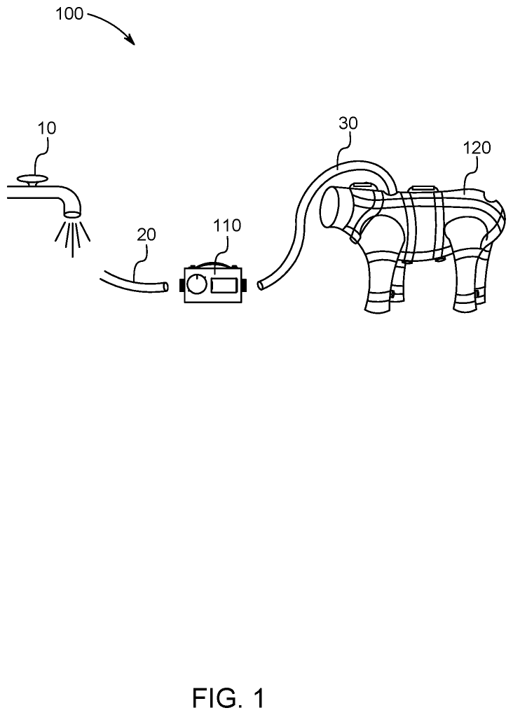

FIG. 1 illustrates a perspective view of an animal cleaning system 100, according to an exemplary embodiment of the present general inventive concept.

The animal cleaning system 100 may include a liquid control unit 110, a wearable cleaning device 120, at least one haptic unit 130, and a power source 140, but is not limited thereto.

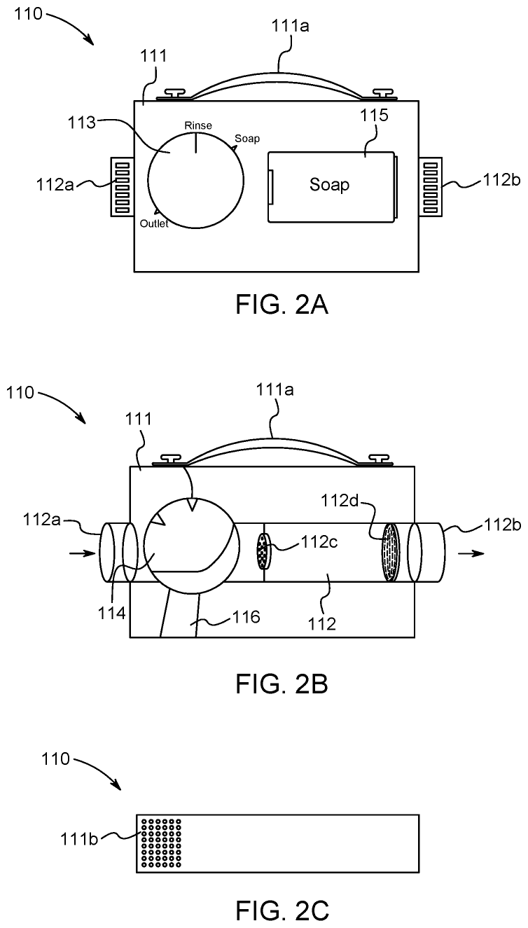

FIG. 2A illustrates a front view of a liquid control unit 110, according to an exemplary embodiment of the present general inventive concept.

FIG. 2B illustrates a front sectional view of the liquid control unit 110, according to an exemplary embodiment of the present general inventive concept.

FIG. 2C illustrates a bottom view of the liquid control unit 110, according to an exemplary embodiment of the present general inventive concept.

The liquid control unit 110 may be constructed from at least one of metal, plastic, glass, and rubber, etc., but is not limited thereto.

Referring to FIGS. 2A through 2C, the liquid control unit 110 may include a body 111, an inner tube 112, a selector 113, a valve 114, a cleaning liquid container 115, and an auxiliary tube 116, but is not limited thereto.

Referring again to FIGS. 2A through 2C, the body may include a handle 111a and a water outlet 111b, but is not limited thereto.

The handle 111a may be disposed on at least a portion of a top surface of the body 111. The handle 111a may facilitate gripping and/or carrying the body 111. The water outlet 111b may be disposed on at least a portion of a bottom surface of the body 111. Specifically, the water outlet 111b may be a plurality of apertures to allow a liquid (e.g., water) to flow therethrough.

The inner tube 112 may include a first end 112a, a second end 112b, a cleaning liquid cover 112c, and a water filter 112d, but is not limited thereto.

Referring to FIGS. 1 through 2B, the inner tube 112 may be disposed within at least a portion of an interior of the body 111. A faucet 10 may be connected to a first end of a first hose 20. Additionally, the first end 112a of the inner tube 112 may be removably connected to a second end of the first hose 20. As such, water from the faucet 10 may flow through the first hose 20 into the liquid control unit 110.

The selector 113 may include a button, a dial, a knob, a switch, and a lever, but is not limited thereto.

The selector 113 may be disposed on at least a portion of the body 111. The selector 113 may have options to be selected based on a preference of a user. For example, the selector 113 may select an outlet position, a rinse position, and/or a soap position, but is not limited thereto. Moreover, the selector 113 may rotate in a first direction (i.e. clockwise) or a second direction (i.e. counterclockwise) from a first position to a second position, such that the user may control flow of the water within the body 111.

More specifically, the valve 114 may rotate in response to a rotation of the selector 113. As such, the cleaning liquid cover 112c may move to release a cleaning liquid (e.g., soap) from the cleaning liquid container 115 in response to rotation of the selector 113 to the soap position, such that the water moves through the valve 114 and the cleaning liquid to create a cleaning solution. The cleaning solution may flow through the water filter 112d and out the second end 112b of the inner tube 112. The water filter 112d may prevent impurities within the water from moving out the second end 112b of the inner tube 112.

Alternatively, only the water may flow through the water filter 112d and out the second end 112b of the inner tube 112 in response to rotation of the selector 113 to the rinse position. In other words, the cleaning liquid cover 112c may move to close access to the cleaning liquid within the cleaning liquid container 115, such that the cleaning liquid may not mix with the water does to create the cleaning solution.

Alternatively, the water may flow through the auxiliary tube 116 in response to rotation of the selector 113 to the outlet position. As such, the water may flow out the water outlet 111b, such that the user may feel the water to adjust a temperature of the water before adjusting the selector 113 to the soap position and/or the rinse position.

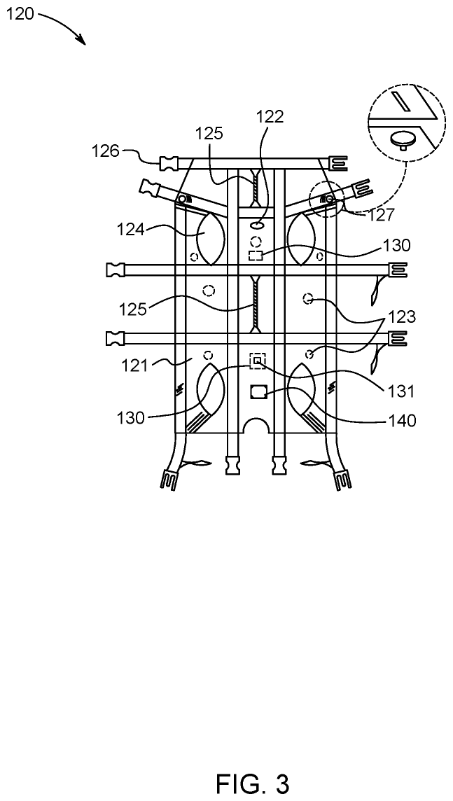

FIG. 3 illustrates a top view of a wearable cleaning device 120, according to an exemplary embodiment of the present general inventive concept.

The wearable cleaning device 120 may be constructed from at least one of metal, plastic, cloth, and rubber, etc., but is not limited thereto. Additionally, the wearable cleaning device 120 may be flexible and highly resistant to water damage.

The wearable cleaning device 120 may include a body 121, a liquid inlet 122, a plurality of liquid outlets 123, a limb-receiving aperture 124, a plurality of handles 125, a plurality of body fasteners 126, and a neck fastener 127, but is not limited thereto.

The body 121 may be of any predetermined size based on a size of a pet of the user. Alternatively, the body 121 may stretch and/or contract to fit the size of the pet. The body 121 may fit any type of pet, such as a cat and/or a dog, but is not limited thereto. Additionally, the body 121 may be a bladder, such that the liquid may be received therein.

The liquid inlet 122 may be removably connected to a first end of a second hose 30, and a second end of the second hose 30 may be removably connected to the second end 112b of the inner tube 112. As such, the water flowing through the liquid control unit 110 may flow into the wearable cleaning device 120. As such, the body 121 may receive the water from the second hose 30.

The plurality of liquid outlets 123 may be disposed on at least a portion of a surface of the body 121 directed towards at least a portion of a body of the pet.

At least one limb of the pet may be inserted through at least one of the plurality of limb-receiving apertures 124 to facilitate the body 121 being worn by the pet.

The plurality of liquid outlets 123 may release the cleaning solution or the water over at least a portion of the body of the pet, based on the selector 113 being moved to the soap position or the rinse position, respectively. As such, the user may wash the pet using the cleaning solution and rinse the cleaning solution off the pet with the water. Moreover, the user may massage the pet using the body 121, such that the pet may relax during the cleaning process. In other words, the wearable cleaning device 120 may comfort the pet, such that the wearable cleaning device 120 may facilitate cleaning of the pet.

The plurality of handles 125 may be disposed on at least a portion of the body 121. The plurality of handles 125 may facilitate gripping and/or carrying the body 121, such that the user may move the pet during cleaning and/or prevent the pet from moving in response to holding at least one of the plurality of handles 125.

The plurality of body fasteners 126 may include a clasp, a button, a snap, a clamp, hooks and loops, and a zipper, but is not limited thereto.

The plurality of body fasteners 126 may fasten the body 121 against at least a portion of the body of the pet to prevent the body 121 from falling off therefrom.

The neck fastener 127 may include a clasp, a button, a snap, a clamp, hooks and loops, and a zipper, but is not limited thereto.

The neck fastener 127 may fasten the body 121 against at least a portion of a neck of the pet to prevent the body 121 from falling off therefrom.

The at least one haptic unit 130 may include a button 131, but is not limited thereto.

The at least one haptic unit 130 may be disposed on and/or within at least a portion of the body 121. The at least one haptic unit 130 may turn on and/or turn off in response to the button 131 being depressed. Furthermore, the at least one haptic unit 130 may vibrate in response to being turned on, such that the body 121 may vibrate to massage the pet. As such, the pet may relax during cleaning by the user.

The power source 140 may include a power inlet and/or a battery, such as lithium-ion, nickel cadmium, nickel metal hydride, alkaline, etc., but is not limited thereto.

The power source 140 may be disposed on and/or within at least a portion of the body 121. The power source 140 may provide power to the at least one haptic unit 130, but is not limited thereto.

Therefore, the animal cleaning system 100 may be an ideal solution for cleaning pets. The animal cleaning system 100 may control the cleaning process by directing the flow of the soap and the water. Additionally, the animal cleaning system 100 may facilitate the cleaning process by massaging the pet, such that the pet may be less likely to move due to relaxation from the massage.

An animal cleaning system 100 to wash a pet with a liquid, the animal cleaning system 100 may include a liquid control unit 110 to control movement of the liquid therethrough, and a wearable cleaning device 120 removably disposed on at least a portion of the liquid control unit 110 to dispense the liquid on at least a portion of the pet.

The liquid control unit 110 may include a body 111, an inner tube 112 disposed within at least a portion of an interior of the body 111 to contain the liquid therein, and a selector 113 rotatably disposed on at least a portion of the body 111 to select a flow of the liquid within the body 111.

The liquid control unit 110 may further include a valve 114 disposed within at least a portion of the interior of the body 111 to adjust the flow of the liquid within the body 111 in response to rotation of the selector 113.

The flow of the liquid within the body 111 is based on at least one of an outlet position, a soap position, and a rinse position.

The wearable cleaning device 120 may include another body 121, and at least one liquid outlet 123 disposed on at least a portion of a surface of the another body 121 to release the liquid from within the another body 121.

The animal cleaning system 100 may further include a haptic unit 130 disposed on or within at least a portion of the wearable cleaning device 120 to massage the pet in response to vibration of the haptic unit 130.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An animal cleaning system to wash a pet with a liquid, the animal cleaning system comprising:
a liquid control unit to control movement of the liquid therethrough; and
a wearable cleaning device removably disposed on at least a portion of the liquid control unit to dispense the liquid on at least a portion of the pet.

2. The animal cleaning system of claim 1, wherein the liquid control unit comprises:
a body;
an inner tube disposed within at least a portion of an interior of the body to contain the liquid therein; and
a selector rotatably disposed on at least a portion of the body to select a flow of the liquid within the body.

3. The animal cleaning system of claim 2, wherein the liquid control unit further comprises:
a valve disposed within at least a portion of the interior of the body to adjust the flow of the liquid within the body in response to rotation of the selector.

4. The animal cleaning system of claim 2, wherein the flow of the liquid within the body is based on at least one of an outlet position, a soap position, and a rinse position.

5. The animal cleaning system of claim 1, wherein the wearable cleaning device comprises:
another body; and
at least one liquid outlet disposed on at least a portion of a surface of the another body to release the liquid from within the another body.

6. The animal cleaning system of claim 1, further comprising:
a haptic unit disposed on or within at least a portion of the wearable cleaning device to massage the pet in response to vibration of the haptic unit.
